(19) United States
(12) Patent Application Publication
(10) Pub. No.: US 2024/0151150 A1
(43) Pub. Date: May 9, 2024

(54) TRANSITION WITH UNEVEN SURFACE

(71) Applicant: Siemens Energy Global GmbH & Co. KG, Munich, Bayern (DE)

(72) Inventors: Christian Beck, Essen (DE); Timothy A. Fox, Simcoe, Ontario (CA); Michael A. Heminger, Fort Mill, SC (US); Simon Purschke, Berlin (DE)

(73) Assignee: Siemens Energy Global GmbH & Co. KG, Munich, Bayern (DE)

(21) Appl. No.: 18/274,999

(22) PCT Filed: Jan. 4, 2022
(86) PCT No.: PCT/EP2022/050061

§ 371 Date: Jul. 29, 2023

Related U.S. Application Data
(60) Provisional application No. 63/150,889, filed on Feb. 18, 2021.

(30) Foreign Application Priority Data
May 12, 2021 (EP) 21173613.7

(51) Int. Cl. F01D 9/02

(52) U.S. Cl. CPC F01D 9/023; F05D 2260/2214

(57) ABSTRACT

A transition of a combustion section of a gas turbine includes a bulge and an exit frame and a channel wall in-between. A flow channel crosses the transition from an upstream end to a downstream end. The transition includes at the outer side of the channel wall an uneven surface with dents and troughs to improve the heat transfer without lowering the stream of cooling air.

### CROSS REFERENCE TO RELATED APPLICATIONS

This application is the US National Stage of International Application No. PCT/EP2022/050061 filed 4 Jan. 2022, and claims the benefit thereof, which is incorporated by reference herein in its entirety. The International Application claims the benefit of European Application No. EP21173613 filed 12 May 2021 and the benefit of U.S. Provisional Application No. 63/150,889 filed 18 Feb. 2021.

### FIELD OF INVENTION

The invention relates to a transition adapted to guide hot combustion gases from a combustor to a turbine inlet of a gas turbine.

### BACKGROUND OF INVENTION

A transition is commonly used in a gas turbine to connect a combustor with an inlet of an expansion turbine. In the combustor fuel is burned with air and the hot gas passes the transition causing a high terminal stress on the wall of the transition. Due to the high temperatures of the hot gas, it is necessary to cool the wall of the transition from the outside. Therefore, usually the combustion air, which has been compressed by a compressor of the gas turbine, is used as cooling air at the transition before the combustion air is guided into the combustor.

From the state-of-the-art different solutions to cool the transition with a flow of cooling air are known. The common approach uses ribs or something similar on the outer side to increase the heat transfer. In order not to disturb the flow of the cooling air more than necessary it is preferred to arrange the ribs extending in a direction parallel to the cooling flow. As this is in some cases not sufficient to achieve the necessary cooling of the transition wall the ribs are arranged across to the direction of the cooling flow, as for example shown in US 20140109577 A1. This enables a beneficial transfer of heat from the wall of the transition to the cooling air. Also, solutions with the spiral arrangement of the ribs surrounding the transition are known from the state-of-the-art. As the solutions to increase the heat transfer by the use of ribs are well known, the optimized arrangement of the ribs could be determined without much effort.

The US 20100205972 A1 shows a further example for a transition with an outer surface comprising features to increase the heat transfer. Here in a regular pattern with raised bars and blocks.

However, there is the need to enable sufficient heat transfer without hindering the cooling flow more than necessary. The task for the current invention is to find a new solution with a sufficient heat transfer with a less disturbed cooling flow along the transition.

### SUMMARY OF INVENTION

The task is solved by a transition according to the independent claim. Advantageous solutions are the subject of the sub claims.

The generic transition is part of the combustion section and is usually arranged downstream of the combustion chamber. A practical use for another purpose is not apparent. Thereby, the transition is used preferably in a gas turbine. The purpose of the transition is to guide hot combustion gas in a direction of flow from an upstream end to a downstream end. In use of the transition on the upstream side the combustion chamber is arranged. If used at a gas turbine on the downstream side a turbine inlet of the gas turbine is arranged. Here, the transition comprises the bulge arranged at the upstream end. Opposite on the downstream end and exit frame is arranged. Between the bulge and the exit frame the transition comprises a channel wall. Inside the transition from the bulge through the channel wall to the exit frame flow channel enables the flow of the hot combustion gas from the upstream side to the downstream side.

To enable a sufficient heat transfer from the transition wall to the cooling air the transition comprises means for an increase of the heat transfer compared to a smooth surface. Therefore, the solution makes use of an uneven surface. This uneven surface is characterized by an arrangement of dents and troughs, whereby it is provided that the uneven surface has a surface height from the bottom of the troughs to the top of the dents of at least 3 mm and at most 20 mm.

The dents and troughs could be arranged in different patterns to build the uneven surface. The inventive transition makes use of a certain arrangement of the dents and troughs. Here, adjacent to each of the dents four troughs are arranged. Vice versa adjacent to each of the troughs four dents are arranged for the inventive solution. This pattern enabled the beneficial heat transfer. It is obvious that this arrangement is not possible along the edge of the uneven surface. Further it is possible, that due to the three-dimensional shape of the channel wall or due to other features arranged on the outer side of the channel wall, some of the dents or troughs also do not have four adjacent troughs respectively dents.

To achieve the beneficial heat transfer it is further necessary that a certain distance ratio has to be fulfilled. The distance ratio is defined by the distance of adjacent dents relative to the surface height. Here, the distance ratio has to be at least 1 and at most 5.

Next, the sufficient heat transfer could only be achieved by the inventive solution if at least 80% of the outer side of the channel wall comprises the uneven surface with dents and troughs. In this respect, that surface is meant where all dents are surrounded by four troughs and all troughs are surrounded by four dents.

With this new inventive solution by use of a certain uneven surface and sufficient heat transfer could be achieved by decreasing the disturbance of the cooling flow and thereby enabling an increase of the efficiency of a combustion section, especially if used as component of a gas turbine.

If the channel wall of the transition has a certain wall thickness it is especially advantages to use the inventive solution with the uneven surface. Here, the wall thickness should be at least 3 mm, which is the distance from the bottom of the troughs to the inner surface at the inner side of the channel wall. On the other hand, the wall thickness should not exceed 30 mm, which is the distance between the top of the dents to the inner surface. The use of the inventive solution with the uneven surface is in particular advantage if the wall thickness is at least 6 mm and at most 22 mm. Within this range the sufficient heat transfer from the channel wall to the cooling air could be achieved and the allowable material temperatures for the complete transition can be maintained.

To achieve a beneficial heat transfer with the uneven surface it is in particular advantageous if the uneven surface extends at least over 59% of the outer surface of the channel wall on the outer side. This enables the use of nearly all of the possible area to achieve a beneficial heat transfer from the channel wall to the cooling air.

It has been found out that a sufficient heat transfer with an improvement of the cooling flow (less hindering of the cooling flow) could be achieved if the surface height of the uneven surface is advantageous between 6 mm and 15 mm. It is advantageous, if the surface height is at least 8 mm and at most 12 mm. This is the best compromise between on the one hand a sufficient heat transfer by the disturbance of the cooling flow and also the increase of the surface area and on the other hand a lowest possible disturbance of the cooling flow, which is just necessary to achieve the sufficient heat transfer.

Next, it is particularly advantageous, if the distance ratio between the distance of adjacent dents to the surface height is between 2 and 3. This enables an optimized heat transfer with less disturbance of the cooling flow.

In principle the dents and troughs could be designed with different shapes. Though it is in particular advantageous if the uneven surface is a wavelike, smooth and continuous shape. This enables a smooth flow of the cooling air along the channel wall and yet a sufficient disturbance of the cooling flow and a beneficial heat transfer. Here, it is possible to use a mathematical function like a sine wave to define the uneven surface with the dents and troughs.

The arrangement of dents and troughs to generate the uneven surface leads to a first row of dents along a first curve along a first direction. A first section cut through the uneven surface along the first row of dents leads to a first curve height. Considering the arrangement of dents at the uneven surface, a second section cut through the uneven surface along the second row of dents leads to a second curve height. It is possible but not necessary that the first curve for the first row of dents and/or the second curve for the second row of dents is a straight-line. Here, a second curve with the second row of dents along a second direction is arranged across the first direction of the first curve with the first row of dents.

By the analyses of the heat transfer of the uneven surface it has been found, that it is advantageous if the difference between the first curve height and the second curve height is at least 0.1 times and at most 0.4 times the surface height of the uneven surface.

In general, the shape of the transition must be adapted to the design of the combustion section. Nevertheless, it is advantageous if the bulge has a revolving shape. The simplest design is therefore the shape of the ring disc protruding to the outer side. This enables a beneficial mounting inside the combustion section by considering the terminal stress and also the sealing to adjacent components. This needs further to more or less circular shape of the flow channel at the upstream end.

It is a further advantage if the exit frame has an approximate trapezoidal shape. This enables a beneficial sealing to the adjacent component and furthermore an oblong shape of the flow channel at the downstream end. To enable the mounting of the transition at the exit frame it is further advantage to arrange a fastening device at the exit frame. If used in a gas turbine it is beneficial if there fastening device is arranged on the longer side of the trapezoidal shape of the exit frame.

The transition comprises at the upstream side an upstream flange face. The shape of the flange face is at first not relevant and represents the outer end of the bulge facing the upstream side as a smooth surface. On the opposite side the transition comprises at the downstream side a downstream flange face. Analogue the shape is not relevant at first and the downstream flange face represents the outer end of the exit frame facing the downstream side as a smooth surface.

Nevertheless, it is advantageous if the bulge comprises on the upstream side a planar upstream flange face and analogue if the exit frame comprises on the downstream side planar downstream flange face.

The extension of the upstream flange face and the extension of the downstream flange face leads to a definition of an intersection curve. If the upstream flange face and also the downstream flange face are planar an intersection line is given.

In principle the inventive solution of the transition could be used in different arrangements of adjacent components. But the use of the transition with the uneven surface is useful if the adjacent components are oriented relative to each other at a certain angle. Here, it is advantageous if a flange angle between the upstream flange face and the downstream flange face is at least 20° and at most 45°. The usage of the inventive solution is in particular advantageous if the flange angle is at least 25° and at most 40°.

The usage of the inventive uneven surface is further beneficial if the transition considering the flange angle and the size of the flow channel comprises a rather short shape.

Therefore, a section cut square to the intersection curve could be analyzed at the position of the biggest channel height of the flow channel at the upstream end—the upstream channel height. Further, the distance from the intersection curve to the flow channel at the upstream end could be determined. Here, it is advantageous if the distance from the intersection curve to the flow channel is at least 0,5 times and at most 1 time the upstream channel height. It is in particular advantageous if the distance is at least 0,6 times and at most 0,8 times the upstream channel height.

In a further section cut (which could be the same then the section cut before) square to the intersection curve through the transition with the biggest height of the flow channel at the downstream end with the downstream channel height also the distance from the flow channel to the intersection curve could be determined. Here, it is advantageous if the distance is at least 1.5 times and at most 3 times the downstream channel height. It is in particular advantageous, if the distance is at least 2 times and at most 2,5 times the downstream channel height.

To enhance the cooling of the channel wall it is further advantage to integrate several cooling channels within the channel wall between the uneven surface and the inner surface of the channel wall. Thereby it is advantage to arrange the cooling channels with their extension along the direction of flow of the hot gas inside the flow channel.

To enable sufficient cooling of the exit frame it is advantage to extend at least some of the cooling channels into the exit frame. It is in particular advantageous, if first cooling channels have a first input at the downstream end in the exit frame and the first output at the upstream end in the channel wall. To enable a useful flow of cooling air through the first cooling channels the first opening in the exit frame is arranged facing the upstream side. The first output is provided at the inner side of the channel wall facing the flow channel. This enables the flow of cooling air from the exit frame through the channel wall upstream and into the flow channel.

Analogue it is advantage to extend at least some of the cooling channels into the bulge. It is in particular advantageous, if second cooling channels have a second input at the upstream end in the bulge and a second output at the downstream end in the channel wall. Preferably the first input is provided in the bulge facing the downstream side or on the radial outer side. The second output is arranged in the channel wall at the inner side facing the flow channel. This enabled the flow of cooling air from the bulge through the channel wall downstream into the flow channel.

Thereby it is possible to combine two or more inputs with a cross connection from where the cooling channels distribute further. The preferred solution instead uses the arrangement of one input for one cooling channel.

With the use of first cooling channels and also of second cooling channels it is further advantageous to arrange the first cooling channels and the second cooling channels in the channel wall alternately.

The transition could be produced in different ways however to achieve the uneven surface with its dents and troughs it is in particular advantageous to use an additive manufacturing process. Thereby it is further advantage to build the transition with its bulge and channel wall and exit frame as one piece or alternatively from two pieces each produced by an additive manufacturing process, whereby the two pieces are welded together.

### BRIEF DESCRIPTION OF THE DRAWINGS

In the following figures an example for in inventive transition is shown:

FIG. 1 shows a schematic view of a gas turbine;

FIG. 2 shows an isometric view of an example of an inventive transition, whereby the uneven surface is not shown;

FIG. 3 shows half-section of the transition from FIG. 2;

FIG. 4 shows a detailed view of the uneven surface;

FIG. 5 shows a first section cut through the uneven surface along the first row of dents;

FIG. 6 shows a second section cut through the uneven surface along the second row of dents;

FIG. 7 shows a further cut through the uneven surface at the troughs;

FIG. 8 shows in a schematic view the arrangement of the first cooling channels in the channel wall;

FIG. 9 shows in a schematic view the arrangement of the second cooling channels in the channel wall;

FIG. 10 shows a section cut through the transition with the flange angle between the upstream side and downstream side.

### DETAILED DESCRIPTION OF INVENTION

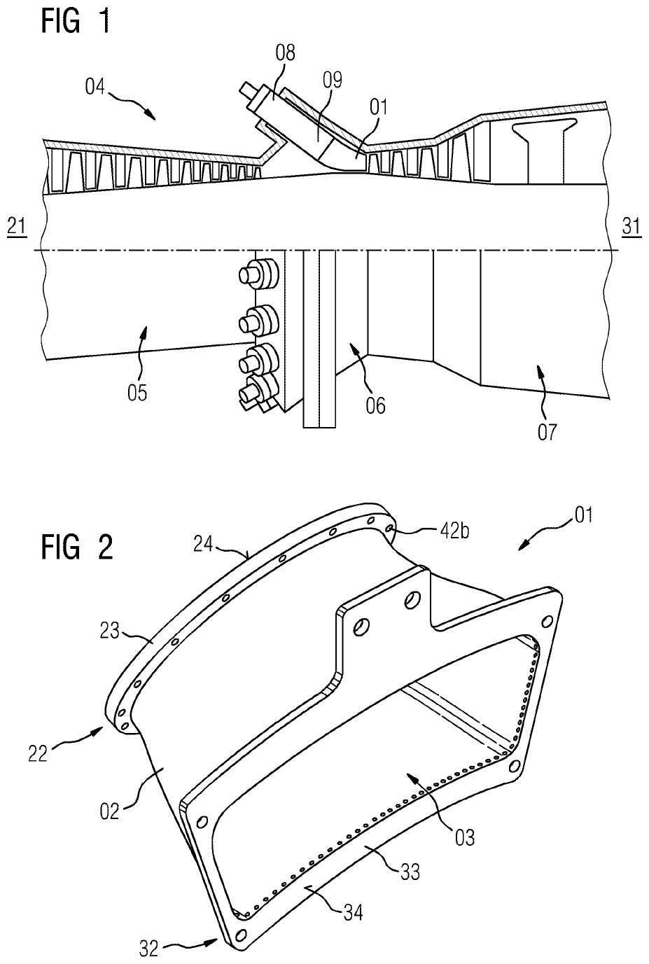

In FIG. 1 a schematic sketch of a gas turbine 04 is shown. The gas turbine 04 defines an upstream side 21 and a downstream side 31 and comprises a compressor section 05 and a combustion section 06 and an expansion turbine section 07. The combustion section 06 comprises further an arrangement of burner 08, each connected with a combustion chamber 09. The connection between the combustion chamber 09 and a turbine inlet of the expansion turbine section 07 is realized by transition 01.

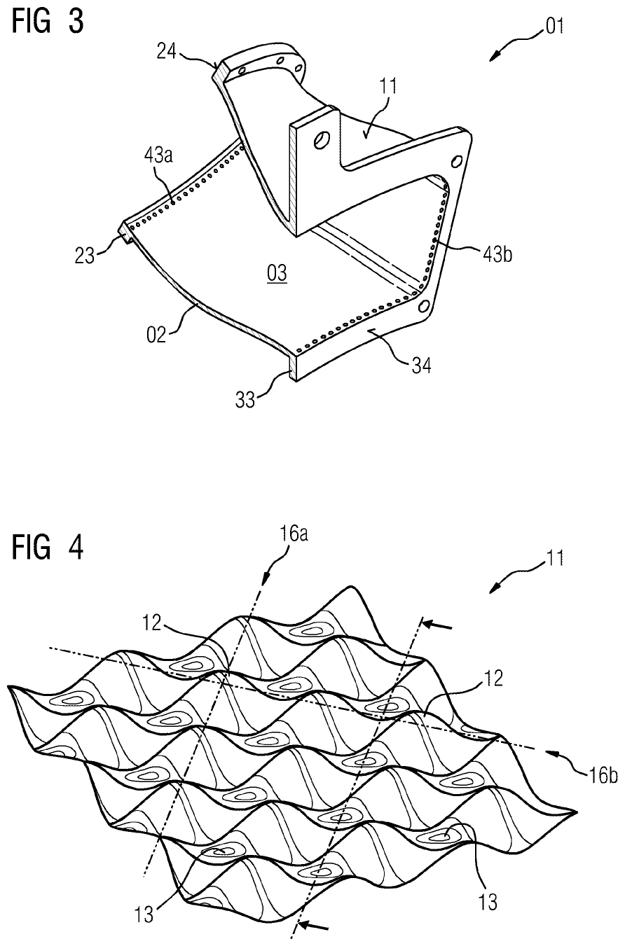

In FIG. 2 an example for a transition 01 is shown in an isometric view. The details for the uneven surface—even this is the key for the invention—is omitted due to the complexity of the graphical demonstration (see FIG. 4). In FIG. 3 the same is sketched in a half-section cut. First of all, the transition 01 comprises a channel wall 02 extending from an upstream end 22 tone downstream end 32. The invention provides an uneven surface 11 on the outer side of the channel wall 02. The transition 01 is crossed from the upstream end 22 to the downstream end 32 by the flow channel 03 through which in use the hot gas flows.

At the upstream end 22 a bulge 23 is arranged having a shape of a ring disc. At the upstream side 21 and upstream flange face 24 is defined. Further, a number of second inputs 42b are arranged on the downstream side 31 at the bulge 23 as the start of second cooling channels. At the opposite side, an exit frame 33 is arranged at the downstream end 32. At the downstream side 31, a downstream flange face 34 is defined by the exit frame 33. Further a number of first outputs 43a and second output 43b are arranged on the inner side of the channel wall 02 at the upstream end 22, respectively, opposite at the downstream end 32.

FIG. 4 shows in an example a detailed view on the uneven surface 11 as the key feature for the inventive transition 01. The uneven surface 11 comprises an arrangement of dents 12 and troughs 13, wherein each dent 12 is surrounded by four troughs 13 and each trough 13 is surrounded by four dents 12. The arrangement enables the determination of first row of dents 16a along a first curve and cross to the first curve along a second curve the determination of second row of dents 16b. What could be seen next is the wavelike shape of the uneven surface 11.

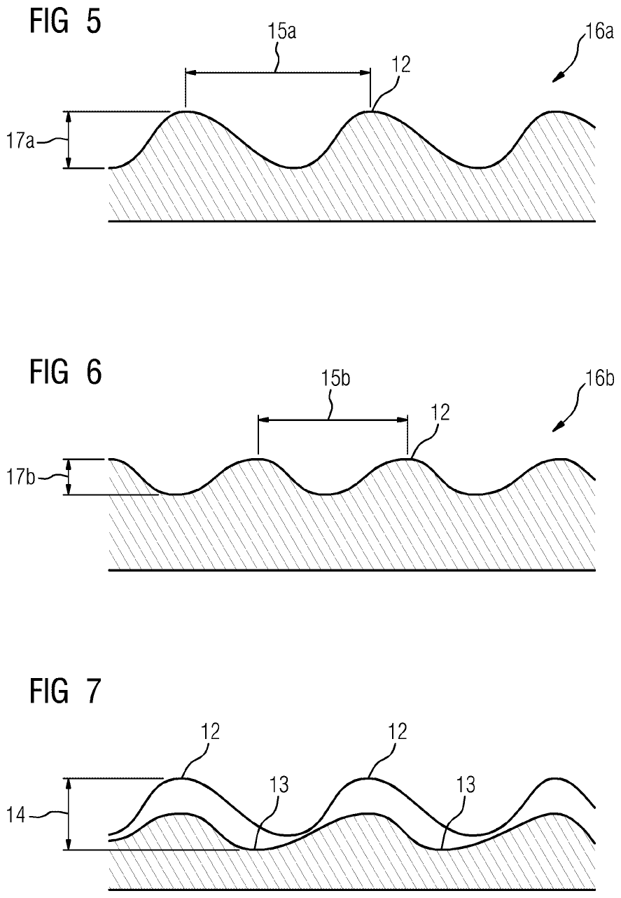

FIG. 5 shows a section cut through the uneven surface 11 along the first row of dents 16a. Here the pattern of the dents 12 with the certain first distance 15a between adjacent dents 12 and further first curve height 17a of the uneven surface 11 in this first section cut could be seen.

Analogue FIG. 6 shows a section cut through the uneven surface 11 along the second row of dents 16b. In this direction, a second distance 15b between adjacent dents 12 and also a second curve height 17b could be determined.

In FIG. 7 a further section cut through the uneven surface 11 is shown, wherein in this case the section cut is made through the troughs 13. Here, the surface height 14 of the uneven surface 11 from the bottom of the troughs to the top of the dents 12 is visible.

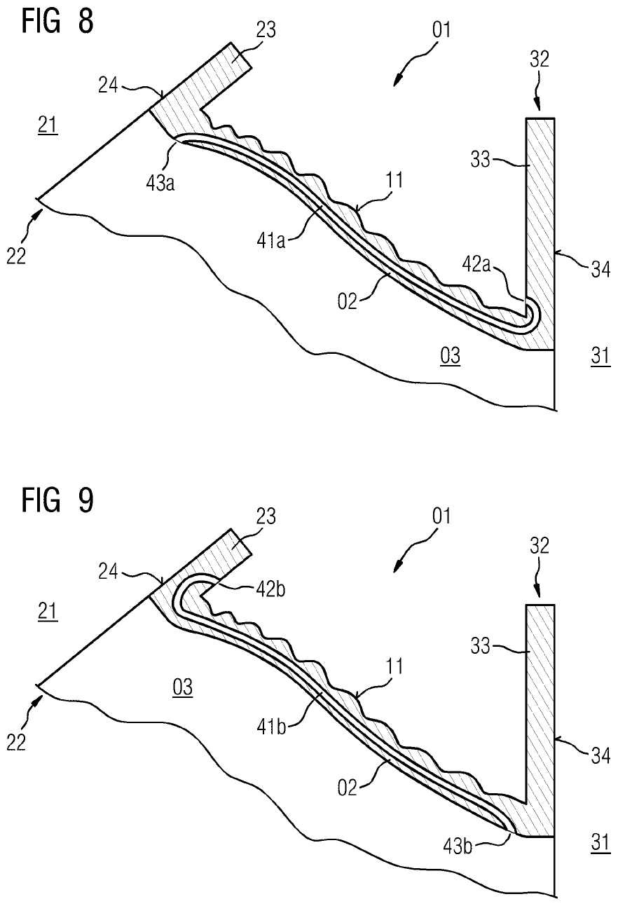

In FIG. 8 and analogue in FIG. 9 the arrangement of cooling channels 41 inside the channel wall 02 is shown in a section cut through the transition 01. In the exit frame 33 at the downstream end 32 on the upstream side 21 a first input is arranged. From there, a first cooling channel 41a extends through the channel wall 02 to the upstream end 22 and leads to our first output 43a on the inner side of the channel wall 02. Beside the first cooling channel 41a second cooling channel 41b is arranged with a second input 42b in the bulge 23 at the upstream end 22 with the opening facing the downstream side 31. Here, the second output 43b of the second cooling channel 41b is at the downstream end 32 again on the inner side of the channel wall 02.

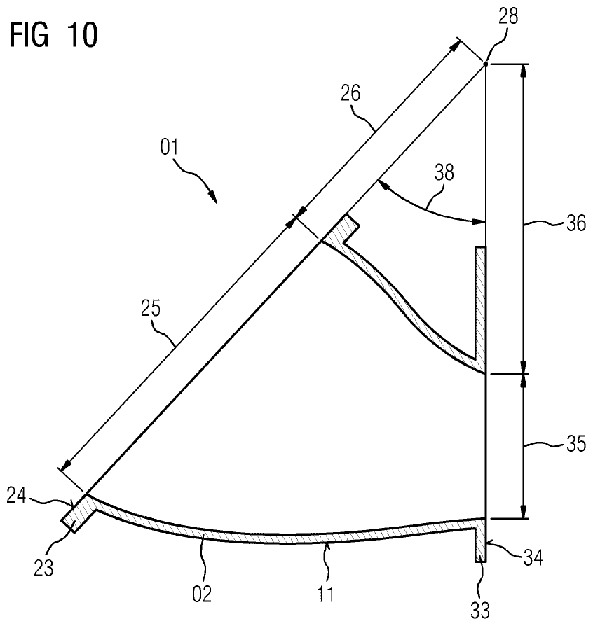

In FIG. 10 a further section cut through the exemplary transition 01 with the channel wall 02 and the bulge 23 at the upstream end 22 and the exit frame 33 at the downstream end 32 and the cooling channel 03 inside is shown. On the upstream side 21 the transition 01 defined an upstream flange face 24, which is planner in this exemplary design of a transition 01. On the opposite downstream side 21 a planar downstream flange face 34 is arranged. This as the flange faces 24, 34 are angled to each other the extension of the flange faces 24, 34 define an intersection line 28. Further between the flange faces 24, 34 a flange angle 38 is given. In this exemplary transition 01 the flange angle is about 40°.

The advantage solution of the transition 01 has certain relative portions between the distance to the intersection line 28 and the size of the flow channel 03. At the upstream end 22 the upstream distance 26 between the flow channel 03 and the intersection line 28 is about three-quarters of the upstream flow channel height 25. At the downstream end 33 the downstream distance 36 between the flow channel 03 and the intersection line 28 is about twice the downstream channel height 35.

### LIST OF REFERENCE NUMERALS

01 transition
02 channel wall
03 flow channel
04 gas turbine
05 compressor section
06 combustion section
07 expansion turbine section
08 burner
09 combustion chamber
11 uneven surface
12 dent
13 trough
14 surface height
15a first distance of adjacent dents
15b second distance of adjacent dents
16a first row of dents
16b second row of dents
17a first curve height
17b second curve height
21 upstream side
22 upstream end
23 bulge
24 upstream flange face
25 upstream channel height
26 upstream distance
28 intersection line
31 downstream side
32 downstream end
33 exit frame
34 downstream flange face
35 downstream channel height
36 downstream distance
38 flange angle
41a first cooling channel
41b second cooling channel
42a first input
42b second input
43a first output
43b second output

1. A transition of a combustion section, in particular of a gas turbine, to guide hot combustion gas in a direction of flow from a combustion chamber at an upstream side to a downstream end, in particular to a turbine inlet of the gas turbine, comprising:
a bulge arranged at an upstream end,
an exit frame arranged at the downstream end,
a channel wall extending from the bulge to the exit frame, and
a flow channel extending from the bulge through the channel wall to exit frame,
wherein the channel wall has on an outer side at least over 80% an uneven surface with dents and troughs having a surface height of at least 3 mm and at most 20 mm,
wherein each dent has four immediately adjacent troughs, and each trough has four immediately adjacent dents, wherein a distance ratio of a distance between adjacent dents relative to the surface height is at least 1 and at most 5.

2. The transition according to claim 1,
wherein the channel wall has a wall thickness of at least 3 mm and at most 30 mm; and/or
wherein the channel wall has at least over 95% on the outer side an uneven surface; and/or
wherein the surface height is at least 6 mm and at most 15 mm; and/or
wherein the distance ratio is at least 2 and at most 3.

3. The transition according to claim 1,
wherein the uneven surface has a wavelike shape.

4. The transition according to claim 1,
wherein the uneven surface has along a first row of dents a first curve height and along a second row of dents across the first row of dents a second curve height, wherein a difference between the first curve height and the second curve height is at least 0.1 times and at most 0.4 times the surface height.

5. The transition according to claim 1,
wherein the bulge has a revolving shape, in particular the shape of a ring disc protruding to the outer side; and/or
wherein the exit frame has an approximate trapezoidal shape with a fastening device arranged on a longer side of exit frame.

6. The transition according to claim 1,
wherein a flange angle between an upstream flange face at the upstream end and a downstream flange face at the downstream end is at least 20° and at most 45°.

7. The transition according to claim 6,
wherein the upstream flange face and/or the downstream flange face are/is planar.

8. The transition according to claim 6,
wherein an extension of the upstream flange face and an extension of the downstream flange face define an intersection curve respectively an intersection line.

9. The transition according to claim 8,
wherein in a section cut square to the intersection curve the flow channel has an upstream channel height at the upstream end, wherein a distance from the intersection curve to the flow channel at the upstream end is at least 0.5 times and at most 1 time, the upstream channel height.

10. The transition according to claim 8,
wherein in a section cut square to the intersection curve the flow channel has a downstream channel height at the downstream end, wherein a distance from the intersection curve to the flow channel at the downstream end is at least 1.5 times and at most 3 times, the downstream channel height.

11. The transition according to claim 1, further comprising:
serval cooling channels extending at least partly within the channel wall, in particular along the direction of flow.

12. The transition according to claim 11,
wherein at least some of the cooling channels extend into the bulge and/or into the exit frame.

13. The transition according to claim 12,
wherein first cooling channels have a first input in the exit frame on upstream side and a first output in the channel wall at the upstream end on an inner side; and/or
wherein second cooling channels have a second input in the bulge on the downstream side and/or the outer side and a second output in the channel wall at the downstream end on the inner side.

14. The transition according to claim 13,
wherein the first cooling channels and the second cooling channels are arranged alternately.

15. The transition according to claim 1,
built as one piece with an additive manufacturing process; or
built from two pieces each with an additive manufacturing process welded together.

16. The transition according to claim 2,
wherein the channel wall has a wall thickness of at least 6 mm and at most 22 mm.

17. The transition according to claim 6,
wherein a flange angle between an upstream flange face at the upstream end and a downstream flange face at the downstream end is at least 25° and at most 40°.

18. The transition according to claim 9,
wherein the distance from the intersection curve to the flow channel at the upstream end is at least 0.6 times and at most 0.8 times, the upstream channel height.

19. The transition according to claim 10,
wherein a distance from the intersection curve to the flow channel at the downstream end is at least 2 times and at most 2.5 times, the downstream channel height.
